(19) United States
(12) Patent Application Publication
(10) Pub. No.: US 2003/0073776 A1
(43) Pub. Date: Apr. 17, 2003

(54) Manufacture methods of short filament and multi-color pattern coating material

(76) Inventors: Jong Soo Cho, Gyeonggi-do (KR); In Ki Kim, Seosan (KR)

Correspondence Address: Anderson Kill & Olick, 1251 Avenue of the Americas, New York, NY, 10020, US

(21) Appl. No.: 10/239,280

(22) PCT Filed: Mar. 16, 2001
(86) PCT No.: PCT/KR01/00419

(30) Foreign Application Priority Data
Mar. 18, 2001 (KR) 2000/13826

(51) Int. Cl. C08K 3/00

(52) U.S. Cl. 524/501; 524/502

(57) ABSTRACT

The present invention relates to a process for preparing a short filamentous coating material and a multi-coloring patterned coating material for finishing an interior and exterior building. More specifically, the present invention relates to a process for preparing an environmental friendly short filamentous coating material and a multi-coloring patterned coating material, wherein the short filamentous coating material allows particles of an aqueous coloring polymer to be a short fiber, thereby converting the structure of the dry coating layer upon drying into the short filamentous structure, and the multi-coloring patterned coating material can express the multi-coloring patterns such as wallpaper or marble pattern by coating said coating material only once. The coating materials of the present invention are an environmental friendly product having a good appearance, a good balance between moisture permeation and water resistance, a good penetrative adhesion, and an excellent interior and exterior exposure, so it can be applied to various fields.

### FIELD OF THE INVENTION

The present invention relates to processes for preparing a short filamentous coating material and a multi-coloring patterned coating material for finishing an interior and exterior of building. More specifically, the present invention relates to processes for preparing a short filamentous coating material and a multi-coloring patterned coating material as environmental friendly materials, wherein the short filamentous coating material allows particles of an aqueous coloring polymer to be a short filament, thereby converting the structure of the dry coating layer upon drying into the short filamentous structure, and the multi-coloring patterned coating material can express the multi-coloring patterns such as wallpaper or marble pattern by coating said coating material only once.

### BACKGROUND OF THE INVENTION

In textile industry, a short filament generally means a fiber of short length, and a short filamentous coating material means a coating material having the structure of short fiber. Hitherto, only coating materials have been prepared by mixing the binder with fibers such as short-cut cotton yarn in situ. Thus it cannot be mentioned that a substantial short filament has been developed.

Also, as a multi-coloring coating material, a lacquer organic solution is used by being coagulated with water, or viscous solution containing polyurethane such as polymer coating composition for forming patterns as disclosed in Korean Patent Publication Nos. 99-185199 and 99-215141, which have been invented by one of the inventors of the present invention, is scoured with an inorganic material to be insoluble and is used as a composite with two or more colors; or a coagulate is formed with a hydrophobic polymer solution by using an electrolyte as a coagulating source, and then coagulated to form multi-color particles.

But, the coating materials prepared by the above conventional methods have many problems in their functions and appearance to be coated. The short filamentous coating material prepared from a cotton yarn cannot be coated exteriorly, and it is a costly product because of using expensive cotton yam, and it brings about an increase of cost due to the dyeing, and an environmental pollution due to the waste water. In addition, it also causes an environmental pollution by mixing short fiber with a binder in situ and the resulting wastewater. It is also troublesome for combining short filaments with a binder in situ. Furthermore, there are problems that the coating layer is formed coarsely and the pattern is monotonous.

Furthermore, a lacquer-containing multi-coloring patterned coating material has a low durability and is easily contaminated, so a transparent coating film is formed in the form of airtight film to protect its surface. In the coating material, the moisture and gas emitted from internal part cannot be exhausted well, thereby resulting in occurring the adverse effect of accelerating the aging of the structure and the steel reinforcing of the building, and in earlier exfoliation of the coating material. Generally, multi-coloring coating material for forming a coating layer with pattern is a mixture of volatile organic solutions such as toluene, M.E.K., M.I.B.K., ethyl acetate, and the like, it results in a great waste of resources, a fire hazard due to handling the dangers, and occupational disease harmful to workers. Furthermore, when the above coating material is coated, it is a burden on the workers and their neighbors with the danger and injury due to volatilizing organic solvents, and it results in the environmental pollution such as atmospheric pollution.

To solve these problems, the present invention is to provide multi-functional short filamentous coating materials and multi-coloring patterned coating materials as environmental friendly materials by using a water-soluble polymer as a binder, which have a good appearance, a good moisture permeability and water resistance, a good penetrative adhesion, an excellent interior and exterior exposure durability, and also have various uses.

### DETAILED DESCRIPTION OF THE INVENTION

The present invention is to provide a process for preparing a short filamentous coating material comprising the steps of: mixing 54.6 to 75.2% by weight of a high hydrated composition comprising sodium carboxymethylcellulose dissolved in water, 7.5 to 10.9% by weight of a coloring binder, and 7.5 to 10.9% by weight of a polyacrylic emulsion (solid content: 40 to 50%); gradually adding 4.5 to 10.9% by weight of an aqueous solution of metal complex salt including aluminum sulfate thereto during 3 to 15 minutes to conduct a coordination bond reaction and a fibrosis with scouring by a simultaneous coagulating granulation; rotationally scouring by adding 0.7 to 1.6% by weight of dimethyl silicone oil to the mixture; and adding 4.5 to 10.9% by weight of an aqueous solution of sodium-silcon as an aqueous polymer solution for reinforcing physical properties.

The present invention also is to provide a multi-coloring patterned coating material, which is characterized in mixing a composition with various colors and patterns in a desired ratio with the short filamentous coating material.

In this specification and the appended claims, “scouring” means a process for forming a short filamentous particle with its diameter of about 1 to 5 mm by repeatedly scratching or polishing the surface of the particles and subsequently forming the particles to be a porous structure via dehydration.

### BRIEF DESCRIPTION OF DRAWINGS

FIG. 1a shows the structure of a short filamentous particle (11) containing water (12), which is formed on the coating material by the high hydrated composition according to the present invention.

FIG. 1b shows the structure of a dehydrated coating layer after coating a short filamentous coating material according to the present invention. In FIG. 1b, 12′ indicates a pore formed by dehydration.

FIG. 2a is a cross sectional view to show a coating layer (23) of acrylic polymer formed by applying conventional aqueous coating material to a coated material (21) having high porosity (22).

FIG. 2b is a cross sectional view to show the formation of a coating layer (24) of silicon polymer to be used in the present invention.

FIG. 3 is a cross sectional view to show moisture permeation (32) through the pores and waterproof in a dry coating layer (24) after coating a short filamentous coating material according to the present invention. In FIG. 3, the arrow (33) indicates that water drop and contaminant are left on the coating layer instead of being penetrated therein.

FIG. 4 is a cross sectional view to show the formation of a coating layer of a multi-coloring patterned coating material according to the present invention. In FIG. 4, 11″ are short filamentous particles with various colors, 22 is pore, and 24′ is a silicon polymer as a protective layer.

### PREFERRED EMBODIMENT OF THE INVENTION

The high hydrated composition of the present invention is prepared by adding slowly 0.5 to 5% by weight of sodium carboxymethylcellulose (C₆H₉OCH₂COONa) to 95 to 99.5% by weight of water with stirring in the rotary mixer. The high hydrated composition, which is a reactant of the coordinate bonding reaction, allows the coating particles to keep soft by preventing dehydration and coagulation during the reaction on account of its high hydration capacity. Also, it has a moisture permeable structure with minute pores through keeping empty the dehydrated portion of particles in a dry coating layer.

The high hydrated composition of the present invention is preferable to use 54.6 to 75.2% by weight, in order to form its coating width of at least 30 μm by coating only once on forming the dry coating layer after coating the short filamentous coating material of the present invention.

The coloring binder of the present invention is an indispensable material of a coating material for masking the structure to be coated and forming a coating layer thereto, and it is a coagulate comprising 10 to 20% by weight of polyacrylic emulsion (solid content: 40 to 50%), 10 to 20% by weight of titanium oxide as a masking pigment, 2 to 10% by weight of aluminum silicate as a pigment aid, 10 to 20% by weight of calcium carbonate and 5 to 15% by weight of talc as an extender filler, 0.1 to 1% by weight of sodium polyacrylate as an inorganic dispersing agent, and 5 to 15% by weight of H.E.C. (Hydroxyethyl cellulose) aqueous solution (3% of solid content) as a thickening agent. The binder may further comprise various additives for coating material such as paint. The specific examples of composition of the above coloring binder are shown in the following Tables 1 (general type) and 2 (silk type).

TABLE 1
(General type)

| Additive | Component | kg/% |
|---|---|---|
| Diluent | Water | 48.6/17.4689 |
| Freezing stabilizer | Propylene glycol | 5.4/1.94099 |
| Inorganic dispersing | Sodium polyacrylate | 2.296/0.82528 |
| agent | | |
| Binder | Polyacrylic emulsion | 48.6/17.4689 |
| Surfactant | Secondary higher alcohol | |
| | sulfuric ester salt | 0.972/0.3493 |

Premix I 10 minutes/300 rpm

| | | |
|---|---|---|
| Pigment 1 | Rutile type-Titanium dioxide | 47/16.8938 |
| Pigment 2 | Aluminum silicate | 16.48/5.9236 |
| Extender filler 1 | Calcium carbonate | 37/13.2992 |
| Extender filler 2 | Talc | 32.9/11.8256 |

Premix II 15 minutes/200-300 rpm

| | | |
|---|---|---|
| Defoaming agent | Photocompound containing | 0.162/0.0582 |
| | defoaming agent¹⁾ | |

Premix III 20 minutes/300-400 rpm

| | | |
|---|---|---|
| Adhesive agent | 2,2,4-trimethyl-1,3- | 1.296/0.4658 |
| | pentanediolisobutyrate | |
| Thickening/ | 3% H.E.C. aqueous solution | 35.64/12.8205 |
| antiprecipitating agent | | |
| Thixotropic thickener | acryl sol²⁾ | 1.2/0.4313 |
| pH controlling agent | 5% 2-amino-2-methyl-1- | 0.5/0.1797 |
| | propanol | |
| Defoaming agent | Photocompound containing | 0.162/0.0582 |
| | defoaming agent¹⁾ | |
| Antiseptic agent | Kathon 1 × 1.5% | 0.222/0.08 |
| | (Rohm & Hass) | |

Premix IV 20 minutes/300-400 rpm
(total processing time: 65 minutes)

| | |
|---|---|
| Total | 278.208 kg/ |
| | 100.08927% |

¹⁾Product of NOPCO NXZ-KOREASAN NOPCO CO., LTD
²⁾Product of ACRYLSOL RM-2020NPR ROHM & HAAS

Said premixes I-IV are differentiated by the time of adding depending on the mixing condition of composition, each premixes are subsequently added with stirring in a rotary mixer.

TABLE 2
(Silk type)

| Additive | Component | kg/% |
|---|---|---|
| Diluent | Water | 48.6/17.4689 |
| Freezing stabilizer | Propylene glycol | 5.4/1.94099 |
| Inorganic dispersing | Sodium polyacrylate | 2.296/0.82528 |
| agent | | |
| Binder | Polyacrylic emulsion | 48.6/17.4689 |
| Surfactant | Secondary higher alcohol | |
| | sulfuric ester salt | 0.972/0.3493 |

Premix I 10 minutes/300 rpm

| | | |
|---|---|---|
| Silk color pigment 1 | Pearl | 133.38/47.9422 |

Premix II 15 minutes/200-300 rpm

| | | |
|---|---|---|
| Defoaming agent | Photocompound containing | 0.162/0.0582 |
| | defoaming agent¹⁾ | |

Premix III 20 minutes/300-400 rpm

| | | |
|---|---|---|
| Adhesive agent | 2,2,4-trimethyl-1,3- | 1.296/0.4658 |
| | pentanediolisobutyrate | |
| Thickening/ | 3% H.E.C. aqueous solution | 35.64/12.8205 |
| antiprecipitating agent | | |
| Thixotropic thickener | acryl sol²⁾ | 1.2/0.4313 |
| pH controlling agent | 5% 2-amino-2-methyl-1- | 0.5/0.1797 |
| | propanol | |
| Defoaming agent | Photocompound containing | 0.162/0.0582 |
| | defoaming agent¹⁾ | |
| Antiseptic agent | Kathon 1 × 1.5% | 0.222/0.08 |
| | (Robin & Hass) | |

Premix IV 20 minutes/300-400 rpm
(total processing time: 65 minutes)

| | |
|---|---|
| Total | 278.208kg/ |
| | 100.08927% |

¹⁾Product of NOPCO NXZ-KOREASAN NOPCO CO., LTD
²⁾Product of ACRYLSOL RM-2020NPR ROHM & HAAS

Said premixes I-IV are differentiated by the time of adding according to the mixing condition of composition, each premixes are subsequently added with stirring in a rotary mixer.

Polyacrylic emulsion (solid content: 40 to 50%) of the present invention is a hydrophobic colloid, and it is preferable to use 7.5 to 10.9% by weight, since it becomes unstable if its electric charge is neutralized with an electrolyte when its concentration is a certain value for coagulating, and the dehydration according to an extra coagulation rapidly aroused when it reaches to a certain coagulation value, thereby resulting in an instantaneous precipitation. The pattern of particles may be varied by adjusting the coagulation value of polyacrylic emulsion, in other words, it may be varied depending on the ratio of addition of the polyacrylic emulsion. For example, the area of the coagulated particles may be enlarged by adding a small amount of the following metal complex aqueous solution, and relatively a large amount of polyacrylic emulsion, whereas the area of the coagulated particles becomes smaller and it is possible to form steric particles, if said complex salt and polyacrylic emulsion are added with a large amount in comparison with other components. Thus, the patterns may be variously controlled depending on regulating the ratio of metal complex salt and other components.

The aqueous solution of metal complex salt according to the present invention is prepared by blending 7 to 12% by weight of aluminum sulfate [Al₂(SO₄)₃.xH₂O] with 93 to 88% by weight of water. The above aqueous solution of metal complex salt serves as a coagulation source, and it has a function of modifying a hydrophilic polymer to a hydrophobic polymer through a coordinate bonding reaction of the hydrophilic sodium carboxymethylcellulose. In addition, the above aqueous solution of complex salt may form various types of particles according to its coagulation value. For example, stereographic patterns with circle dots may be formed with a high coagulation value, whereas natural patterns in the form of mane and large particle may be formed with a low coagulation value. Therefore, the aqueous solution of metal complex salt is preferable to use in the amount of 7.5 to 10.9% by weight.

Dimethyl silicon oil according to the present invention is preferable to use in the amount of about 0.7 to 1.6% by weight, and said dimethyl silicon oil assuring that it inhibits the coating material from coagulating, as well as from decomposing by alkali materials to be added therein, and it retards the aging due to the prolonged storage.

Polymer solution for reinforcing physical properties of the present invention is selected among the group consisting of an aqueous solution of silicon polymer, an aqueous solution of sodium-silicon, and an aqueous solution of copolymer made by adding an acrylic polymer to said silicon polymer. Among these, an aqueous solution of sodium-silicon, i.e. an aqueous solution comprising a complex of sodium and silicon is most preferable.

Among the polymer solution, a silicon polymer solution of the present invention is prepared by mixing 20 to 50% by weight of 2,2,4-trimethyl-1,3-pentanediolisobutyrate with 80 to 50% by weight of dimethyl silicon polymer, e.g. dimethyl phenyl silicon polymer, and then reacting at 50 to 90° C. for 6 to 24 hours.

An aqueous solution of sodium-silicon is prepared by mixing 33 to 50% by weight of dimethyl silicon polymer represented by the following formula (I) with 67 to 50% by weight of 40% sodium hydroxide aqueous solution, and then reacting at 50 to 90° C. for 12 to 24 hours. In case where said sodium-silicon solution is used in manufacturing a short filamentous coating material, a hydrophilic and excellent environmental friendly coating material may be obtained. After the finished coating material is coated, sodium hydroxide is gradually diminished by being neutralized with carbonic acid gas in air, and the silicon, which was decomposed with sodium hydroxide, and then become a mono-molecule is polymerized again and recovered its inherent physical properties, resulting in an enhanced water repellency and exposure resistance.

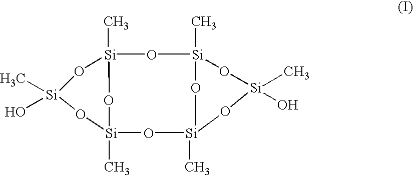

To form a copolymer with said silicon-based polymer and acrylic polymer such as polyacrylic emulsion, 0.5 to 3% by weight of acryl silane KBM 503 (Shin-etsu product, Japan) as a silicon crosslinking agent and 0.1 to 0.5% by weight of tin-based catalyst (Dibutyl tin oxide: DBTO, available from Songwon Industry Co. Ltd., Korea) are blended.

The polymeric aqueous solution for reinforcing physical properties of the present invention is preferable to use in the amount of about 4.5 to 10.9% by weight.

The acrylic materials according to the present invention are as follows:

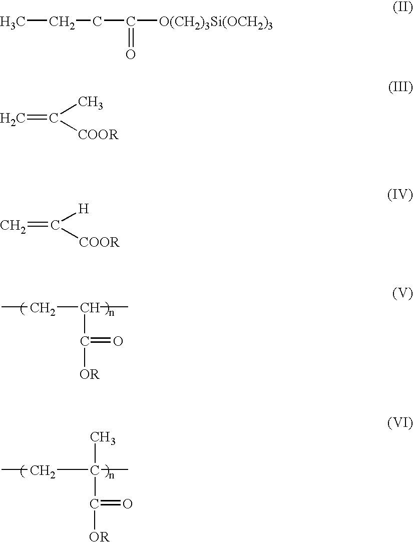

The above compound (II) is acrylsilane, (III) is metacrylate, (IV) is acrylate, (V) is polyacrylate, and (VI) is polymetacrylate.

In the present invention, a short filamentous coating material is prepared from a high hydrated composition (A), a coloring binder (B), a polyacrylic emulsion (C), an aqueous solution of metal complex salt (D), a dimethyl silicon oil (E), and a polymeric aqueous solution for reinforcing physical properties (F).

54.6 to 75.2% by weight of component (A), 7.5 to 10.9% by weight of component (B), and 7.5 to 10.9% by weight of component (C) are first blended by a conventional mixing method in an open vessel. If 4.5 to 10.9% by weight of component (D) is gradually added to the resulting mixture during 3 to 15 minutes, with the mixture being continuously stirred, the following coordinate bond reaction is occurred. In such coordination bond reaction, sulfate ion (SO₄²⁻) of aluminum sulfate which is a chelate in the aqueous solution are liberated by an anion (COO⁻) of sodium carboxymethylcellulose which has a superior coordinate bonding ability, and then moved from coordination complex outwardly, thereby forming a coordination complex, wherein sulfate ions of said aluminum sulfate are replaced by carboxyl ions (COO⁻).

C₆H₉O₄CH₂COONa+[Al(H₂O)₆]₂(SO₄)₃.6H₂O+C₆H₉O₄CH₂COONa→C₆H₉O₄CH₂Na—P[Al₂(OH)₂.(H₂O)₈.COO.COO]P—.C₆H₉O₄CH₂NaSO₄²⁻

In this reaction, an electric charge of mixture is neutralized by a metal ion and an organic polymer is coagulated to form a gel, thereby resulting in a rapid increase of viscosity and a subsequently decrease of fluidity. Therefore, the mixture should be rotationally stirred in every direction at 30 to 40 rpm for 15 to 60 minutes.

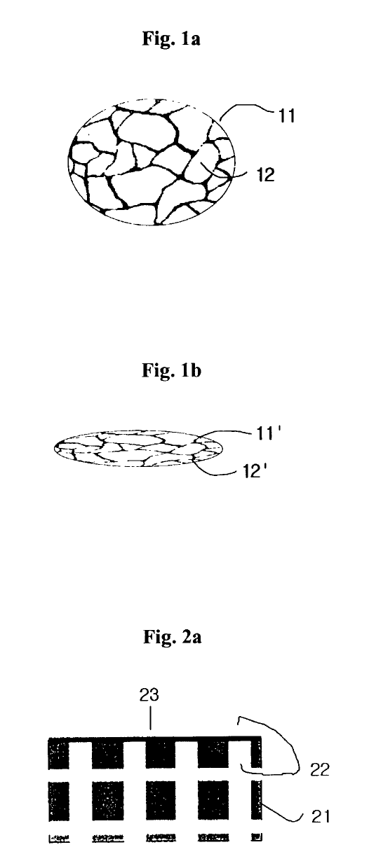

Also, the mixture is formed particles as a gel state, and the particles therein are scoured by a centrifugal force according to the repetitive rotation and the scratch of stirring blades, thereby resulting in the formation of short filaments as shown in FIG. 1a.

In addition, to make the short filament particles of the scouring process more fibrosis and soft, swelling of particles may be optionally carried out by adding 3 to 10% by weight of 0.5% ammonia water.

To impart a releasing property between short filament particles thus formed, to protect from being affected by an alkali or other soluble materials to be added, and to inhibit an undesirable coagulation by an acid or base, 0.7 to 1.6% by weight of component (E) (viscosity of 10 to 1000 cs) are added to said short filament particles for 10 to 40 minutes, and then scoured rotationally. As a result, said component (E) is penetrated in the fibrous pores of particles and then attached thereto.

Then, 4.5 to 10.9% by weight of an aqueous solution of sodium-silicon as a component (F) are added to the resulting mixture. If a coating material for an internal use is required, that is, when high physical properties are not necessary, only polyacrylic emulsion may be added instead of using said component (F) for reducing the cost. The component (F) has a function as a protecting layer of short filamentous particle and as a penetrating adhesion medium on coated materials, and it affords water resistance, contamination resistance, water repellency, and external exposure resistance of a dry coating layer. The aqueous solution of copolymer is prepared by adding 5 to 15% by weight of silicon polymer to 5 to 15% by weight of polyacrylic emulsion (solid content: 40 to 50%). By forming the copolymer, a silicon-acryl copolymer is produced by forming cross-linkage of a silane and a tin catalyst on the coating layer after drying. As a result, the effects such as prevention of contraction of particles on the dry coating layer, penetration and simultaneous adhesion onto the materials to be coated, and a protective layer on the surface are formed thereon as shown in FIGS. 3 and 4.

The structure of the silicon compound or acryl copolymer is as follows:

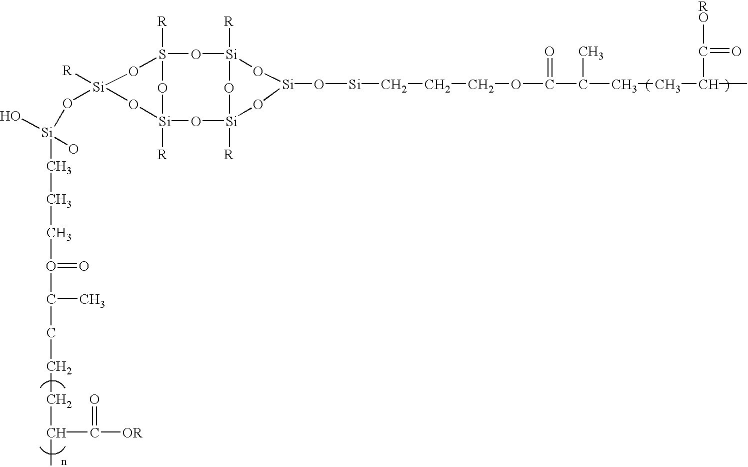

wherein acryl or silicon binds through a silane as shown in site (i), and a tin catalyst promotes this reaction.

Especially, the coating material with various patterns may be obtained by adjusting the amount of each component. Furthermore, multi-coloring patterned coating material having 2 to 5 colors or patterns may be prepared by mixing two or more short filamentous coating materials according to the present invention. Generally, 25 to 75% by weight of white coating material are mixed with 75 to 25% by weight of colored coating material.

Although the invention has been described and illustrated in detail in the examples, it is to be clearly understood that the same is intended by way of illustration and example only and is not to be taken by way of limitation. Accordingly, the spirit and scope of the invention are to be limited only by the terms of the appended claims.

### EXAMPLES 1-3

Example 1 relates to a process for manufacturing a short filamentous coating material. Example 2 relates to a process for manufacturing a multi-coloring patterned coating material. Example 3 relates to a process for manufacturing a silk-typed coating material. Each procedure is respectively carried out with a continuous single process. The components and their amounts used in Examples 1-3 are shown in Tables 3-5, respectively.

TABLE 3

| Components | Amount | |
|---|---|---|
| High hydrated composition | 6500 | g |
| Coloring binder | 2500 | g |
| Polyacrylic emulsion | 1000 | g |
| Conventional auxochromic pigment | 10-300 | g |
| (dispersed in water) | | |

Premix 5-10 minutes/50-400 rpm (with stirring slowly)

| | | |
|---|---|---|
| Metal complex salt aqueous solution | 1200 | g |

Cutting-mixing 30-40 minutes/300-500 rpm
(with fibrosis scouring and stirring continuously)

| | | |
|---|---|---|
| Stabilizer: dimethylsilicon oil (viscosity of 10-1000 | 50-300 | g |
| cs) | | |

Cutting with scouring and stirring 10-30 minutes
(with fibrosis scouring and stirring continuously)

| | | |
|---|---|---|
| Diluent: water | 1000-2000 | g |
| Penetrating adhesive and surface layer forming poly- | 500-1500 | g |
| mer 1-dimethyl phenyl silicon polymer | | |
| Penetrating adhesive and surface layer forming poly- | 500-1500 | g |
| mer 2-polyacrylic emulsion (solid content: 40-50%) | | |

TABLE 4

| Components | Amount | |
|---|---|---|
| High hydrated composition | 7800 | g |
| Coloring binder | 360 | g |
| Polyacrylic emulsion | 1000 | g |
| Conventional auxochromic pigment | 10-300 | g |
| (dispersed in water) | | |

Premix 5-10 minutes/50-400 rpm
(with continuous stirring slowly)

| | | |
|---|---|---|
| Metal complex salt aqueous solution | 10-300 | g |

Cutting-fibrosis scouring and stirring 30-40 minutes/300-500 rpm
(with stirring continuously)

| | | |
|---|---|---|
| Swelling agent: 0.5% ammonia water | 1000 | g |

Cutting-fibrosis scouring and stirring 10-30 minutes
(with stirring continuously)

| | | |
|---|---|---|
| Stabilizer: silicon oil (viscosity of 10-1000 cs) | 50-300 | g |

Cutting-fibrosis scouring and stirring 10-30 minutes
(with scouring and stirring continuously)

| | | |
|---|---|---|
| Diluent: water | 1000-2000 | g |
| Penetrating adhesive and surface layer forming poly- | 500-1500 | g |
| mer 1-dimethyl phenyl silicon polymer | | |
| Penetrating adhesive and surface layer forming poly- | 500-1500 | g |
| mer 2-polyacrylic emulsion (solid content: 40-50%) | | |

TABLE 5

| Components | Amount | |
|---|---|---|
| High hydrated composition | 7800 | g |
| Silk-typed composition | 500-1000 | g |
| Polyacrylic emulsion | 1000 | g |
| Conventional auxochromic pigment | 10-100 | g |
| (dispersed in water) | | |

Premix 5-10 minutes/50-400 rpm
(with continuous stirring slowly)

| | | |
|---|---|---|
| Metal complex salt aqueous solution | 300-800 | g |

Cutting-mixing 30-40 minutes/300-500 rpm
(with fibrosis scouring and stirring continuously)

| | | |
|---|---|---|
| Stabilizer: dimethylsilicon oil(viscosity of 10-1000 cs) | 50-300 | g |

Cutting- scouring and stirring 10-30 minutes
(with fibrosis scouring and stirring continuously)

| | | |
|---|---|---|
| Diluent: water | 1000-2000 | g |
| Penetrating adhesive and surface layer forming poly- | 500-1500 | g |
| mer 1-dimethyl phenyl silicon polymer | | |
| Penetrating adhesive and surface layer forming poly- | 500-1500 | g |
| mer 2-polyacrylic emulsion (solid content: 40-50%) | | |

The physical properties of the short filamentous coating material (sample) of Example 1 prepared by the present invention and conventional multi-coloring patterned coating material (control) are shown in Table 6.

[image]

[image]

As shown above, the conventional multi-coloring patterned coating material cannot be used as an external coating material because of its poor durability. The coating material of the present invention has advantages such as excellent contamination resistance, washing resistance, and durability against discoloration, owing to the physical properties of a silicon compound, when it is used for an internal use; and the above coating material has an excellent external exposure resistance of at least 10 years owing to the use of a silicon compound, when it is used for an external use. Furthermore, the life of buildings may be extended since it has little exfoliation and a good water proof effect owing to integral binding the silicon component of the coating material and that of cement. Meanwhile, the conventional coating material is mainly composed of nitrocellulose, so it is easily flammable on account of its low ignition temperature. On the contrary, the coating material of the present invention is not easily flammable since its ignition temperature is at least 300° C. Especially, if it is burned partially, it affords a flame resistance capable of self-extinguishing for its deficiency of oxygen at the site of burning by forming a carbonized layer thereon.

In comparison with cross sectional views of the two coating materials, it is known that the conventional patterned coating is easily contaminated because its bottom is exposed.

Advantages of the coating material according to the present invention may be summarized as follows:

1. Improved Environmental Affinity

The conventional aqueous patterned coating material has many difficulties in its commercialization on account of a low water resistance of the finished coating layer since said coating material uses an aqueous binder. The present inventors have discovered a process for preparing a coating material having a large hydrophobic group and a high water resistance, which comprises substituting a carboxymethylcellulose having hydrophilic and hydrous properties by a coordinated polymer, wherein a metal ion is linked to polymer through a coordination bond reaction by the complex. Thus, it is possible to manufacture a patterned coating material having an environmental affinity, wherein a complex of sodium-silicon is used as a durable binder, thereby lowering the ratio of volatile organic compounds (VOCs) with 0.5% or less, and thus resulting in an excellent environmental affinity (VOC ratio of paint for internal use 1% or less under Japan environmental affinity regulation, VOC ratio of synthetic resin emulsion paint approved by the Korea Environmental Mark Association: 3% or less).

Especially, it is anxious about an environmental pollution since the conventional wallpaper prepared by forming a PVC soft coating layer on the paper may produce a toxic dioxin at the time of thermal decomposition which is carcinogen, whereas the coating material of the present invention is a environmental friendly coating material which can be replaced by the conventional coating material.

2. Adhesion Exfoliation Strength

Silicon polymer or silicon-acryl copolymer added after completing a short filament process may form a transparent polymer layer having a good fluidity and a high penetrating capacity. It flows into the body to be coated from the fibrosis particles in the liquid coating material after coating and then be easily penetrated deeply to the body (e.g., cement). As a result, it has a strong exfoliation resistance since silicon, which is a major component of cement and the like, and a silicon polymer may produce a simultaneous penetration and adhesion. Furthermore, the transparent silicon polymer layer (24′ in FIG. 4) forming on the surface of the particle has an excellent surface scratch hardness since it does not contain any inorganic material, which causes a deterioration of the physical property.

3. Balance of Moisture Permeability and Water Resistance

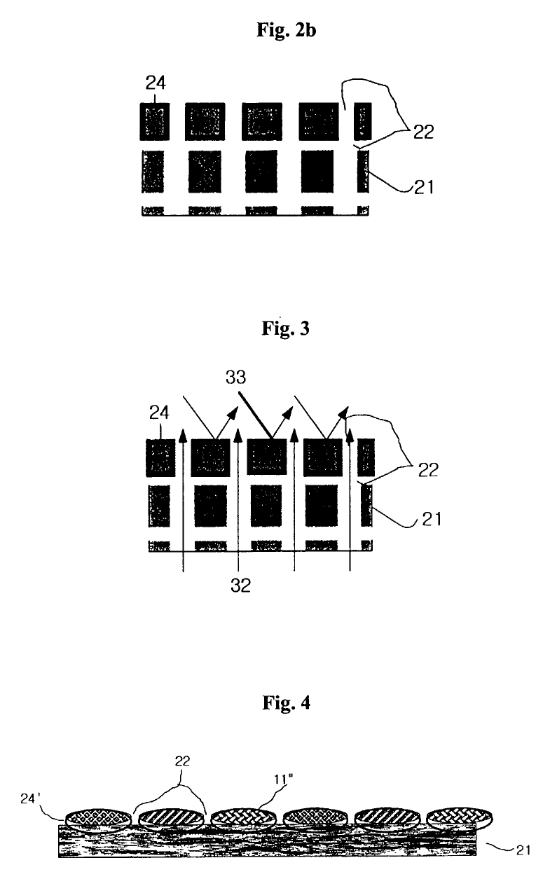

Generally, conventional coating materials for construction have been used with the object of plastering effect. Hence, its coating has been mainly performed in the form of the closed coating layer by neglecting its moisture permeation and water resistance or reducing its functions. However, in the conventional coating material, the moisture emitted from-the inner part of the building and gases resulting from the oxidation are not exhausted outwardly, but permeated into the inner part of the building, thereby causing the proliferation of the mold and the offensive odor as well as promoting the aging. Especially, a corrosive framed structure such as reinforcement is contacted with a large amount of moisture, thereby promoting the oxidation of the framed structure. It results in shortening of the building's life. According to the present invention, a coating layer having a good moisture permeability and water resistance may be obtained, wherein the gases and the moisture may be exhausted outwardly through fine pores (12′ in FIG. 1b) of the fibrous particles. The coating material of the present invention is a composition, which is useful in penetrating the moisture and repelling the water notwithstanding its porosity due to an excellent water resistance and water repellency of the silicon polymer forming a protective layer on the surface of the fibrous particle. Furthermore, the coating layer of silicon polymer, which has a function of an adhesive and particle protector, is permeated inwardly instead of forming a coating film, by which the porous short filament particles of the present invention are maintained in the state of the capillary (22 in FIGS. 2b and 3).

4. Finish Coat of a Porous Body to be Coated

Most of cement structures are generally porous, and there is a difference in their adiabatic dewing ability. Especially, the light blowhole concrete characterizing in the adiabatic dewing ability is a high porous building material, and it has a great effect in the adiabatic dewing ability.

However, in the conventional finish coat, a closed coating layer is generally formed in order to seek after an aesthetic view and water resistance. As a result, it gives an unfavorable effect to the adiabatic dewing ability by impairing its function.

On the contrary, according to the present invention, a coating layer with pores, which can prevent pores for absorbing sound from being plugged when the sound absorbing material is coated, may be formed. Thus, the coating layer of the present invention can be coated well on the porous materials.

5. Superior Appearance

The short filamentous coating material according to the present invention may be obtained with a highly sensitive coating layer having a fibrous feeling. Additionally, it can be formed in the form of solution with pattern particles of other colors, and various patterns such as marble on wallpaper may be expressed with one application.

6. Good Flame Resistance

The conventional coating material having a flame resistance has been prepared by mixing a copolymerizing a chlorinated compound or using other halogen compounds. However, this coating material generates a large amount of toxic gases such as dioxin on fire, and such gases become a main cause for death from suffocation. On the contrary, the present inventors have primarily developed a high heat resistance of the coating layer which is not easily ignited or burnt with the small quantity of heat by changing the composition of the flame resistance. The present flame resistant coating material consists of component (A) (carboxymethylcellulose), and (F) (silicon polymer) and other incombustible inorganic pigments such as titanium oxide or aluminum silicate, in which the inorganic pigment enhances still more a heat resistance. In the above components, the ignition temperature of carboxymethylcellulose, wherein a main component is pulp, in component (A) is about 400 to 500° C., and the transformation temperature of silicon polymer in component (F) is about at least 300° C.

Secondly, the above carboxymethylcellulose, silicon polymer and inorganic pigments may form a large amount of carbides. These materials have a fire extinguishing mechanism by blocking the oxygen with a formation of the carbonized layer on the site of the burning after burning locally.

The present inventors have established an optimum ratio of acryl polymer capable of controlling its ignition, wherein said acryl polymer is easily decomposed by the heat due to its low heat resistance and burnt well with its vaporization, through extensive studies on the flame resistance. As a result, the present inventors have developed an environmental friendly coating material having flame resistance.

The coating material of the present invention may be used for decorating interior or exterior coating of building, moisture permeable and water resistant coating, finished product of light blowhole concrete, finished product of sound absorbent materials, various building materials, coating of furniture, and the like.

1. A process for preparing a short filamentous coating material which comprises:
mixing 54.6 to 75.2% by weight of high hydrated composition including sodium carboxymethylcellulose, 7.5 to 10.9% by weight of a coloring binder, and 7.5 to 10.9% by weight of a polyacrylic emulsion;
adding 4.5 to 10.9% by weight of an aqueous solution of metal complex salt including aluminum sulfate thereto during 3 to 15 minutes to conduct a coordinate bond reaction and fibrosis with scouring by a simultaneous coagulating granulation;
adding 0.7 to 1.6% by weight of dimethyl silicone oil to the mixture, followed by rotationally scouring; and
adding 4.5 to 10.9% by weight of an aqueous solution of sodium-silicon as a polymer solution for reinforcing physical properties to the resulting mixture.

2. The process of claim 1, wherein said high hydrated composition is prepared by gradually adding 0.5 to 5% by weight of sodium carboxymethylcellulose to 95 to 99.5% by weight of water with stirring.

3. The process of claim 1, wherein said coloring binder comprises 10 to 20% by weight of acrylic polymer emulsion (solid content: 40 to 50%), 10 to 20% by weight of titanium oxide as a masking pigment, 2 to 10% by weight of aluminum silicate as a pigment aid, 10 to 20% by weight of calcium carbonate and 5 to 15% by weight of talc as an extender filler, 0.1 to 1% by weight of sodium polyacrylate as a inorganic dispersing agent, and 5 to 15% by weight of H.E.C. aqueous solution (3% of solid content) as a thickening agent

4. The process of claim 3, wherein said coloring binder further comprises one or more additives for coating material selected from the group consisting of diluent, freezing stabilizer, surfactant, defoaming agent, adhesive agent, thixotropic thickener, pH controlling agent, and antiseptic agent.

5. The process of claim 1, wherein said aqueous solution of metal complex salt is prepared by blending 7 to 12% by weight of aluminum sulfate with 93 to 88% by weight of water with stirring.

6. The process of claim 1, wherein said aqueous solution of sodium-silicon is prepared by mixing 33 to 50% by weight of dimethylsilicon polymer with 67 to 50% by weight of 40% sodium hydroxide aqueous solution, and then reacting at 50 to 90° C. for 12 to 24 hours.

7. The process of claim 1, which further comprises swelling the mixture by adding 3 to 10% by weight of 0.5% ammonia water before adding said dimethylsilicon oil.

8. A process for preparing a multi-coloring patterned coating material, which comprises mixing 25 to 75% by weight of white coating materials prepared according to claim 1 with 75 to 25% by weight of one or more coloring materials selected among the short filamentous coating materials prepared according to claim 1.
